(19) United States
(12) Patent Application Publication
(10) Pub. No.: US 2014/0000275 A1
(43) Pub. Date: Jan. 2, 2014

(54) LNG FUEL HANDLING FOR A GAS TURBINE ENGINE

(71) Applicant: ICR Turbine Engine Corporation, Hampton, NH (US)

(72) Inventors: James B. Kesseli, Greenland, NH (US); Frank Wegner Donnelly, North Vancouver (CA)

(73) Assignee: ICR Turbine Engine Corporation, Hampton, NH (US)

(21) Appl. No.: 13/931,438

(22) Filed: Jun. 28, 2013

Related U.S. Application Data
(60) Provisional application No. 61/666,549, filed on Jun. 29, 2012.

(51) Int. Cl. F02C 7/22

(52) U.S. Cl. CPC F02C 7/22
USPC 60/776; 60/734

(57) ABSTRACT

An LNG fuel system for gas turbine engine systems is disclosed that allows more efficient management of cryogenic fuels such as LNG to reduce emissions and improve engine efficiency. In one configuration, an intercooled, recuperated gas turbine engine comprises an LNG tank incorporating a liquid-to-vapor LNG fuel circuit in parallel with a vapor fuel circuit. In a second configuration, an alternate vapor fuel circuit is disclosed. In either configuration, the fuel in the liquid fuel circuit is vaporized and heated by the engine's intercooler or by both the engine's intercooler and/or a heat exchanger on the exhaust. In another configuration, both the fuel in the liquid-to-vapor LNG fuel circuit and the vapor fuel circuit are heated by a heat exchanger on the exhaust.

### CROSS REFERENCE TO RELATED APPLICATION

The present application claims the benefits, under 35 U.S.C. §119(e), of U.S. Provisional Application Ser. No. 61/666,549 entitled “LNG Fuel Handling for a Gas Turbine Engine” filed Jun. 29, 2012 which is incorporated herein by reference.

### FIELD

The present disclosure relates generally to gas turbine engine systems and specifically to methods and apparatuses to manage two phase fuels in order to reduce emissions and improve engine efficiency.

### BACKGROUND

There is a growing requirement for alternate fuels for vehicle propulsion. These include fuels such as, for example, natural gas (both LNG and CNG), bio-diesel, ethanol, butanol, hydrogen and the like. Means of utilizing fuels needs to be accomplished more efficiently and with substantially lower carbon dioxide emissions and other air pollutants such as NOxs.

The gas turbine or Brayton cycle power plant has demonstrated many attractive features which make it a candidate for advanced vehicular propulsion. Gas turbine engines have the advantage of being highly fuel flexible and fuel tolerant. Additionally, these engines burn fuel at a lower temperature than reciprocating engines so produce substantially less NOxs per mass of fuel burned.

Liquefied natural gas (LNG) is a preferred fueling option for some transportation vehicles due to its improved storage density as compared to compressed natural gas (CNG). Insulated LNG tanks contain a 2-phase cryogenic mixture of liquid and vapor in equilibrium. The vapor pressure in the insulated tank varies with ambient temperature, usage, and the fueling intervals. A safety pressure vent is required as the temperature of the mixture warms and the associated vapor pressure rises to about 250 psia, which is the maximum allowable vapor pressure in the transportation sector. Typically, LNG fuels are pumped out of the fuel tank in either the liquid or vapor phase, but not both, using booster pumps. Both these methods result in considerable venting of fuel vapor when the maximum allowable vapor pressure is reached.

There remains a need for innovative ways to manage fuels, and in particular LNG fuels, in ways that can increase gas turbine engine efficiency by managing the LNG vapor in the LNG tank and by utilizing discarded and radiated heat from a gas turbine engine.

### SUMMARY

These and other needs are addressed by the various embodiments and configurations of the present disclosure which directed generally to gas turbine engine systems and specifically to a method and apparatus to manage various fuels, especially cryogenic fuels such as LNG, to reduce emissions and to improve engine efficiency.

In accordance with this disclosure, an engine can include a combustor to combust a fuel and air mixture capable of performing work, a first fuel path from a vessel, containing a fuel having two phases, to the combustor to convey a first portion of the fuel from the fuel-containing vessel to the combustor, and a separate second fuel path from the fuel-containing vessel to convey a second portion of the fuel from the fuel-containing vessel to the combustor. In the fuel-containing vessel, most, or all, of the first portion is in a different phase than most, or all, of the second portion. By way of illustration, an intercooled, recuperated gas turbine engine includes an LNG tank incorporating a liquid-to-vapor LNG fuel circuit in parallel with an LNG vapor fuel circuit. The two parallel fuel circuits are commonly in operational mode for the most part both continuously and simultaneously. The vapor circuit can be controlled by a check valve and fuel control throttle valve. The liquid circuit can include a booster pump and the liquid an be vaporized by passing the liquid LNG through the engine's intercooler. In operation, the vapor circuit preferably has priority. Whenever the engine control unit (“ECU”) demands fuel, its vapor fuel control throttle valve opens. If the vapor pressure in LNG tank is greater than that of the combustion chamber, fuel will flow. The liquid fuel circuit can be activated and provide further fuel delivery when the ECU senses that the vapor throttle valve is wide open and still more fuel is required.

The vapor circuit can be controlled by the ECU which senses the vapor pressure in the LNG tank with a first pressure sensor and the combustor inlet pressure with a second pressure sensor. In the vapor circuit of this configuration, the vapor fuel control throttle valve is controlled by ECU based on the sensed pressures. Whenever ECU demands fuel, it opens the vapor fuel control throttle valve to dispense the requested amount of fuel. If the vapor pressure in the LNG tank as determined by the first pressure sensor is greater than that of the combustion chamber as determined by the second pressure sensor, fuel will flow. The liquid fuel circuit thereby provides additional fuel delivery when the ECU senses that the vapor throttle valve is wide open and still more fuel is required.

The liquid fuel circuit can pass through an integrated intercooler, where the liquid is vaporized, and then, if desired, pass through a heat exchanger or heat jacket on the exhaust stream where the vapor is further heated before being delivered to the combustor.

The vapor fuel circuit can also pass through the heat exchanger or heat jacket on the exhaust stream where the vapor can be further heated before being delivered to the combustor.

In some configurations, there is no vapor booster pump. In other configurations, a vapor booster pump can be included. The advantage of this latter configuration is that the vapor pressure can be pumped down to near atmospheric pressure. Then, when the engine is turned off, the time delay until the maximum allowable vapor pressure is reached, is maximized.

In one embodiment, an engine is disclosed, comprising: (a) a combustor operable to combust a fuel and air mixture capable of performing work; (b) a first fuel path from a vessel containing a fuel comprised of at least two phases, to the combustor to convey a first portion of the fuel from the fuel-containing vessel to the combustor; and (c) a separate second fuel path from the fuel-containing vessel to convey a second portion of the fuel from the fuel-containing vessel to the combustor; wherein, in the fuel-containing vessel, at least most of the first portion is in a different phase than at least most of the second portion and wherein a common fuel-containing vessel contains both the first and second portions and is in fluid communication with the first and second fuel paths. In operation, the second portion of the fuel is selected when at least one of the following is true: (a) the pressure of the first portion of the fuel is outside a selected pressure range and (b) the first portion of the fuel is less than the amount of fuel required by the combustor. Further, the first portion of the fuel is preferably substantially in a vapor phase when removed from the fuel-containing vessel and the second portion of the fuel is substantially in a liquid phase when removed from the fuel-containing vessel.

In the above embodiment, the engine is a gas turbine engine comprising at least first and second turbo-compressor spools, each of the at least first and second turbo-compressor spools output an exhaust gas and further comprising at least one of: (a) an intercooler positioned between the compressors of the first and second turbo-compressor spools operable to transfer a portion of thermal energy in a compressed gas compressed by one of the compressors to at least one of the first and second portions of the fuel prior to introduction into the combustor; and (b) an exhaust heat exchanger positioned downstream of the turbines in the first and second turbo-compressor spools to transfer a portion of thermal energy in the exhaust gas to at least one of the first and second portions of the fuel prior to introduction into the combustor.

In a second embodiment, a method is disclosed, comprising: (a) combusting, by a combustor, a fuel and air mixture to perform work; (b) conveying, by a first fuel path from a fuel-containing vessel to the combustor, a first portion of the fuel in the fuel-containing vessel; and (c) conveying, by a second fuel path from the fuel-containing vessel to the combustor, a second portion of the fuel in the fuel-containing vessel, wherein a common fuel-containing vessel contains both the first and second portions of the fuel and is in fluid communication with both the first and second fuel paths. As noted previously, the first portion of the fuel is preferably substantially in a vapor phase when removed from the fuel-containing vessel and the second portion of the fuel is substantially in a liquid phase when removed from the fuel-containing vessel.

In a third embodiment, a tangible and non-transient computer readable medium is disclosed, comprising microprocessor executable instructions that, when executed, perform at least the following operations: (a) conveying, by a first fuel path from a fuel-containing vessel to a combustor, a first portion of the fuel in the fuel-containing vessel, wherein the combustor combusts a mixture of the fuel and air to perform work; and (b) conveying, by a second fuel path from the fuel-containing vessel to the combustor, a second portion of the fuel in the fuel-containing vessel, wherein a common fuel-containing vessel contains both the first and second portions of the fuel and is in fluid communication with the first and second fuel paths. The computer readable medium further comprises at least the following operations: (a) sensing a vapor pressure in the fuel-containing vessel; (b) sensing a gas pressure at or just upstream of a combustor inlet; and (c) applying at least the following rules: (1) when the combustor requires fuel and the pressure sensed by the first pressure sensor exceeds the pressure sensed by the second pressure sensor, open a fuel control throttle valve to enable the first portion of the fuel to flow from the fuel-containing vessel to the combustor; (2) when the combustor requires fuel and the pressure sensed by the first pressure sensor is less than the pressure sensed by the second pressure sensor and a pump in fluid communication with the first fuel path is not available, do not open the fuel control throttle valve but enable the second portion of the fuel to flow from the fuel-containing vessel to the combustor; (3) when the combustor requires fuel and the pressure sensed by the first pressure sensor is less than the pressure sensed by the second pressure sensor and a pump in fluid communication with the first fuel path is available, activate the pump in fluid communication with the first fuel path, open a fuel control throttle valve to enable the first portion of the fuel to flow from the fuel-containing vessel to the combustor; and (4) when the first portion of the fuel fails to satisfy a fuel requirement of the combustor, enable the second portion of the fuel to flow from the fuel-containing vessel to the combustor to satisfy a fuel requirement of the combustor.

The above-described embodiments and configurations are neither complete nor exhaustive. As will be appreciated, other embodiments of the disclosure are possible utilizing, alone or in combination, one or more of the features set forth above or described in detail below. These and other advantages will be apparent from the disclosure of the disclosure(s) contained herein.

As used herein, a reference to methane also refers to natural gas, a fuel of which methane is the principal component, unless specifically described otherwise. A reference to natural gas also refers to methane unless specifically described otherwise.

The following definitions are used herein:

The phrases at least one, one or more, and/or are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The following definitions are used herein:

The term automatic and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

A combustor as used herein means an apparatus in which a fuel and oxidizer are introduced and combusted, preferably by deflagrating (subsonic) combustion process, adding heat energy to the products of combustion. For example, a combustor may be the combustion chamber of a gas turbine engine or the cylinders of a reciprocating engine.

The term computer-readable medium refers to any storage and/or transmission medium that participate in providing instructions to a processor for execution. Such a medium is commonly tangible and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

CNG means compressed natural gas.

Determine, calculate and compute and variations thereof, as used herein, are used interchangeably and include any type of methodology, process, mathematical operation or technique.

ECU means the engine control unit.

An energy storage system refers to any apparatus that acquires, stores and distributes mechanical or electrical energy which is produced from another energy source such as a prime energy source, a regenerative braking system, a third rail and a catenary and any external source of electrical energy. Examples are a battery pack, a bank of capacitors, a pumped storage facility, a compressed air storage system, an array of a heat storage blocks, a bank of flywheels or a combination of storage systems.

An engine is a prime mover and refers to any device that uses energy to develop mechanical power, such as motion in some other machine. Examples are diesel engines, gas turbine engines, microturbines, Stirling engines and spark ignition engines.

A free power turbine as used herein is a turbine which is driven by a gas flow and whose rotary power drives the principal mechanical output power shaft. A free power turbine is not mechanically connected to a compressor in the gasifier section, although the free power turbine may be in the gasifier section of the gas turbine engine. A power turbine may also be connected to a compressor in the gasifier section in addition to providing rotary power to an output power shaft. This latter configuration is called a turbo-compressor spool.

A heat exchanger as used herein means an apparatus whereby a hot fluid passes through a hot side of the heat exchanger and a cold fluid passes through a cold side of the heat exchanger. The hot fluid and cold fluid are separated by a thermally conductive or thermally radiating barrier and heat energy flows from the hot side to the cold side, thereby heating the colder fluid and cooling the hotter fluid. Examples of thermally conductive heat exchangers are cross-flow and counter flow heat exchangers.

A heat jacket as used herein can be a cross-flow or counter-flow heat exchanger or it can be a jacket that transfers heat by radiative heating. As used herein, a heat jacket may be an annular container surrounding the main flow duct that permits the exchange of heat between the fluid circulating through the heat jacket and the walls of the duct.

An intercooler as used herein means a heat exchanger positioned between the output of a compressor of a gas turbine engine and the input to a higher pressure compressor of a gas turbine engine. Air, or in some configurations, an air-fuel mix is introduced into a gas turbine engine and its pressure is increased by passing through at least one compressor. The working fluid of the gas turbine then passes through the hot side of the intercooler and heat is removed typically by an ambient fluid such as, for example, air or water flowing through the cold side of the intercooler.

LNG means liquified natural gas. Natural gas becomes a liquid when cooled to a temperature of about 111 K or lower at about 1 atmosphere pressure. An LNG “component” refers to a molecular constituent of liquid natural gas regardless of phase.

The term means shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Natural gas is a gas consisting primarily of methane and typically with about 0-20% higher hydrocarbons (primarily ethane). A natural gas “component” refers to a molecular constituent of natural gas regardless of phase.

A prime power source refers to any device that uses energy to develop mechanical or electrical power, such as motion in some other machine. Examples are diesel engines, gas turbine engines, microturbines, Stirling engines, spark ignition engines and fuel cells.

Power density as used herein is power per unit volume (watts per cubic meter).

A recuperator is a heat exchanger that transfers heat through a network of tubes, a network of ducts or walls of a matrix wherein the flow on the hot side of the heat exchanger is typically exhaust gas and the flow on cold side of the heat exchanger is typically gas (for example, air or a fuel-air mixture) entering the combustion chamber.

Regenerative braking is the same as dynamic braking except the electrical energy generated is recaptured and stored in an energy storage system for future use.

A report producing device as used herein is any device or collection of devices adapted to automatically and/or mechanically produce a report. As one example, a report producing device may include a general processing unit and memory (likely residing on a personal computer, laptop, server, or the like) that is adapted to generate a report in electronic format. The report producing device may also comprise a printer that is capable of generating a paper report based on an electronic version of a report.

Specific power as used herein is power per unit mass (watts per kilogram).

Spool means a group of turbo machinery components on a common shaft.

A thermal energy storage module is a device that includes either a metallic heat storage element or a ceramic heat storage element with embedded electrically conductive wires. A thermal energy storage module is similar to a heat storage block but is typically smaller in size and energy storage capacity.

A thermal oxidizer is a type of combustor comprised of a matrix material which is typically a ceramic and a large number of channels which are typically circular in cross section. When a fuel-air mixture is passed through the thermal oxidizer, it begins to react as it flows along the channels until it is fully reacted when it exits the thermal oxidizer. A thermal oxidizer is characterized by a smooth combustion process as the flow down the channels is effectively one-dimensional fully developed flow with a marked absence of hot spots.

A thermal reactor, as used herein, is another name for a thermal oxidizer.

A turbine is any machine in which mechanical work is extracted from a moving fluid by expanding the fluid from a higher pressure to a lower pressure.

Turbine Inlet Temperature (TIT) as used herein refers to the gas temperature at the outlet of the combustor which is closely connected to the inlet of the high pressure turbine and these are generally taken to be the same temperature.

A turbo-compressor spool assembly as used herein refers to an assembly typically comprised of an outer case, a radial compressor, a radial turbine wherein the radial compressor and radial turbine are attached to a common shaft. The assembly also includes inlet ducting for the compressor, a compressor rotor, a diffuser for the compressor outlet, a volute for incoming flow to the turbine, a turbine rotor and an outlet diffuser for the turbine. The shaft connecting the compressor and turbine includes a bearing system.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The present disclosure may take form in various components and arrangements of components, and in various steps and arrangements of steps. The drawings are only for purposes of illustrating the preferred embodiments and are not to be construed as limiting the disclosure. In the drawings, like reference numerals refer to like or analogous components throughout the several views.

FIG. 1 is a prior art schematic representation of an LNG fuel system operating on the vapor phase only.

FIG. 2 is a prior art schematic representation of another LNG fuel system operating on the liquid phase only.

FIG. 3 is a prior art schematic representation for heating a fuel using an integrated intercooler of a gas turbine engine.

FIG. 4 is a prior art schematic representation for heating a fuel using a heat exchanger on the exhaust stream.

FIG. 5 is schematic representation for a method of controlling LNG vapor as a primary fuel and heating a liquid fuel using an integrated intercooler of a gas turbine engine.

FIG. 6 is schematic representation for an alternate method of controlling LNG vapor as a primary fuel and heating a liquid fuel using an integrated intercooler of a gas turbine engine.

FIG. 7 is prior art schematic representation for heating a fuel using an integrated intercooler and a heat exchanger on the exhaust stream of a gas turbine engine.

FIG. 8 is schematic representation for a method of controlling LNG vapor as a primary fuel and heating a liquid fuel using an integrated intercooler and a heat exchanger on the exhaust stream of a gas turbine engine.

FIG. 9 is schematic representation for an alternate method of controlling LNG vapor as a primary fuel and heating a liquid fuel using an integrated intercooler and a heat exchanger on the exhaust stream of a gas turbine engine.

FIG. 10 is schematic representation for another alternate method of controlling LNG vapor as a primary fuel and heating a liquid fuel using an integrated intercooler and a heat exchanger on the exhaust stream of a gas turbine engine.

FIG. 11 is a flow chart illustrating an LNG fuel management system.

FIG. 12 is schematic representation for a method of further controlling LNG vapor pressure.

FIG. 13 is a flow chart illustrating an LNG fuel management system having a vapor fuel booster pump.

To assist in the understanding of one embodiment of the present disclosure the following list of components and associated numbering found in the drawings is provided herein:
Low-Pressure Compressor 1
Intercooler 2
High-Pressure Compressor 3
Recuperator 4
Combustor 5
High-Pressure Turbine 6
Low-Pressure Turbine 7
Free Power Turbine 8
Load 11
Air Inlet 41
Exhaust Outlet 42
Intercooler Fan 45
Exhaust Heat Exchanger 49
LNG Vapor Check Valve 81
LNG Vapor Fuel Throttle Valve 82
LNG Vapor Check Valve 83
First Pressure Sensor 84
Engine Control Unit 85
Second Pressure Sensor 86
LNG Tank 91
LNG Tank Pressure Relief Valve 92
Vapor Pressure Regulator 93
LNG Vapor Booster Pump 95
LNG Liquid in LNG Tank 96
LNG Vapor in LNG Tank 97
LNG Liquid Booster Pump 99
Liquid LNG Path—Tank to Booster Pump 101
Liquid LNG Path—Booster Pump to Vaporizer 102
Vaporized LNG Liquid Path to Combustor 103
LNG Vapor Path—Tank to Combustor 104
Pressure Sensor Circuit Path 105
Engine Control Circuit Path 106
LNG Vapor Path—Tank to Booster Pump 108
LNG Vapor Path—Booster Pump to Combustor 109

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

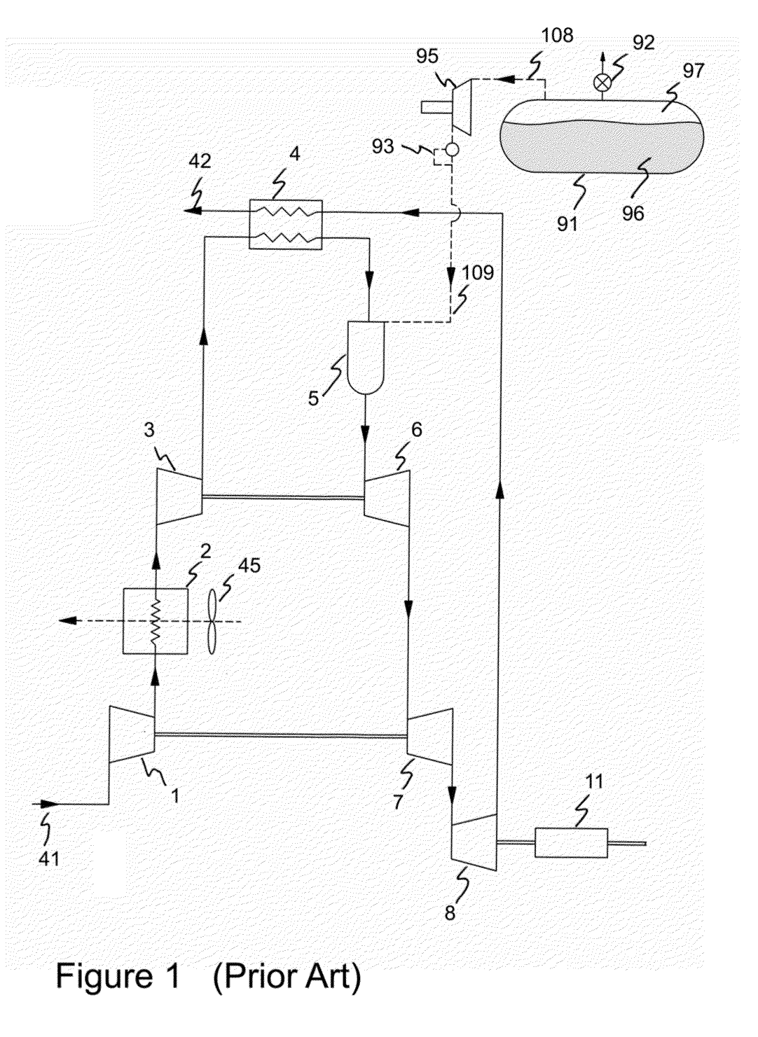

FIG. 1 is a schematic representation of a prior art LNG fuel system for injection of LNG fuel vapor into a gas turbine engine, shown here, for example, as an intercooled, recuperated gas turbine engine. The working fluid gas (typically air) for the gas turbine engine is ingested at inlet 41 into a low pressure compressor 1. The outlet of the low pressure compressor 1 passes through an intercooler 2 which removes a portion of heat from the gas stream at approximately constant pressure. The intercooler is shown with a fan 45 that blows ambient fluid, such as air or water for example, across the intercooler. Both cross-flow and counter-flow intercooler configurations may be used. The working gas then enters a high pressure compressor 3. The outlet of high pressure compressor 3 passes through a recuperator 4 where some heat from the exhaust gas is transferred, at approximately constant pressure, to the gas flow from the high pressure compressor 3. The further heated gas from recuperator 4 is then directed to a combustor 5 where a fuel is burned, adding heat energy to the gas flow at approximately constant pressure. The gas emerging from the combustor 5 then enters a high pressure turbine 6 where work is done by the turbine to operate the high pressure compressor 3. The gas from the high pressure turbine 6 then drives a low pressure turbine 7 where work is done by the turbine to operate the low pressure compressor 1. The gas from the low pressure turbine 7 then drives a free power turbine 8 to which a load 11 is attached. The working fluid exiting the free power turbine 8 then flows through the hot side of recuperator 4 giving up some of its heat energy to the gas flowing through the cold side of recuperator 4. The flow exiting the hot side of recuperator 4 then is exhausted to the atmosphere at outlet 42 which is commonly called the exhaust pipe. In this illustration, the shaft of the free power turbine, in turn, drives a load 11 which may be an electrical, mechanical or hybrid transmission for a vehicle. Alternately, the shaft of the free power turbine can drive an electrical generator or alternator for power generation applications. This engine design is described, for example, in U.S. patent application Ser. No. 12/115,134 filed May 5, 2008, entitled “Multi-Spool Intercooled Recuperated Gas Turbine”, which is incorporated herein by this reference.

This figure also shows an LNG fuel tank 91 and fuel injection equipment. Pressurized natural gas vapor is introduced directly into combustor 5 as shown by path 108 from tank 91 through vapor booster pump 95 and gas pressure regulator 93 and thence by path 109 to combustor 5. The booster pump is typically a gas compressor. LNG tank 91 contains liquid natural gas 96 and natural gas vapor 97 and includes a safety pressure vent valve 92. A gas turbine may operate on the vapor or gaseous phase residing in fuel tank 91, however this pressure is highly variable. A high fueling rate lowers the tank temperature and pressure, often to a pressure below the desired operating level of the gas turbine engine. Booster pump or a gas compressor 95 is included to boost and stabilize the combustor delivery pressure, but cryogenic gas compressors are expensive and have high maintenance.

In this configuration, the methane vapor is stored and injected at approximately 100 K and it would require an approximate enthalpy change of about 418,000 J/kg to bring the vapor up to about room temperature. It is estimated that injecting methane vapor at 100 K directly into the combustor would reduce engine efficiency from its baseline efficiency of about 43.2% (natural gas fuel injected at 298 K) to about 42.8%.

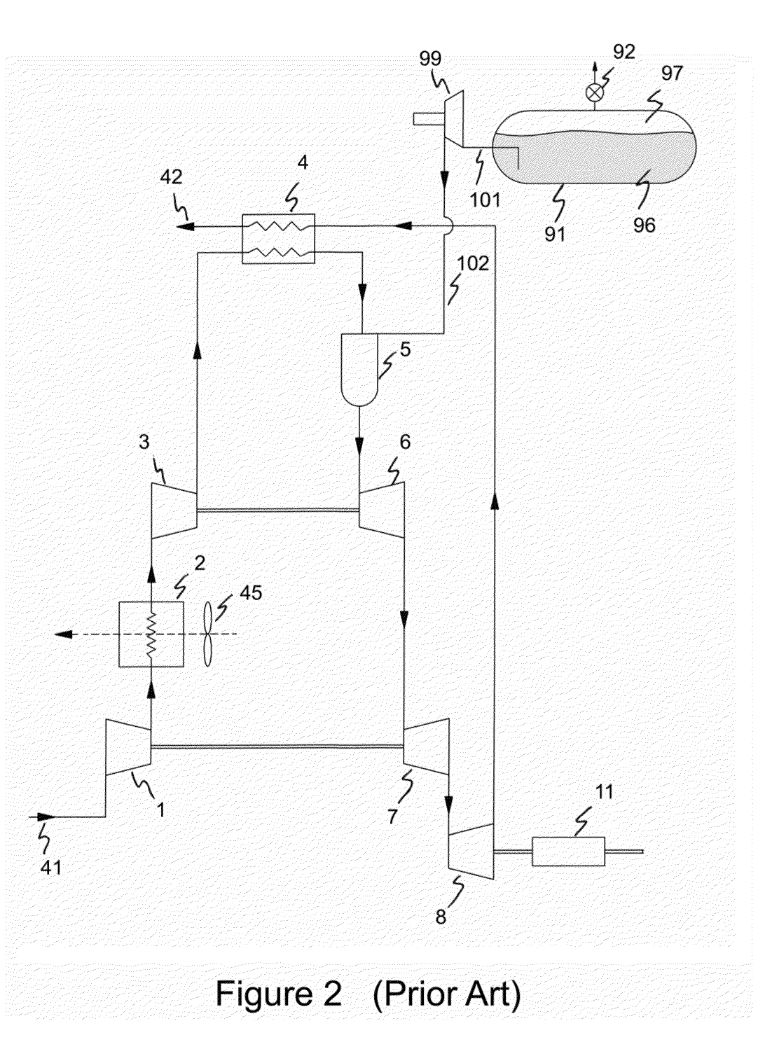

FIG. 2 is a schematic representation of a prior art system for injection of liquid LNG fuel into a gas turbine engine, again shown here as an intercooled, recuperated gas turbine engine. An alternative to delivering gas to the engine is to pump liquid natural gas from the liquid region of tank 91. This is a functional solution, however it has two negative consequences. First, there is a thermodynamic efficiency penalty associated with using heat from the engine's working fluid to substantially vaporize and heat the fuel to combustion temperature; and second, drawing liquid from the tank directly does not result in significant boiling at the liquid-vapor surface. In gas delivery systems (such as shown in FIG. 1), the phase transformation from boiling serves to cool the mixture, thereby preventing or delaying the need to vent gas. This figure shows the same engine components as described in FIG. 1 but wherein liquid natural gas 96 is pumped with a cryogenic booster pump 99 from LNG tank 91 to combustor 5. Liquid natural gas is introduced into combustor 5 as shown by path 101 from tank 91 through booster pump 99 and thence by path 101 to combustor 5. LNG tank 91 contains mainly liquid natural gas 96 and natural gas vapor 97 and includes a safety pressure vent valve 92.

In this configuration, liquid LNG is assumed to be stored at approximately 100 K and it would require an approximate enthalpy change of about 946,000 J/kg to bring the liquid up to a vapor at about room temperature. It is estimated that injecting liquid methane at 100 K directly into the combustor would reduce engine efficiency from its baseline efficiency of about 43.2% (natural gas fuel injected at 298 K) to about 42.4%.

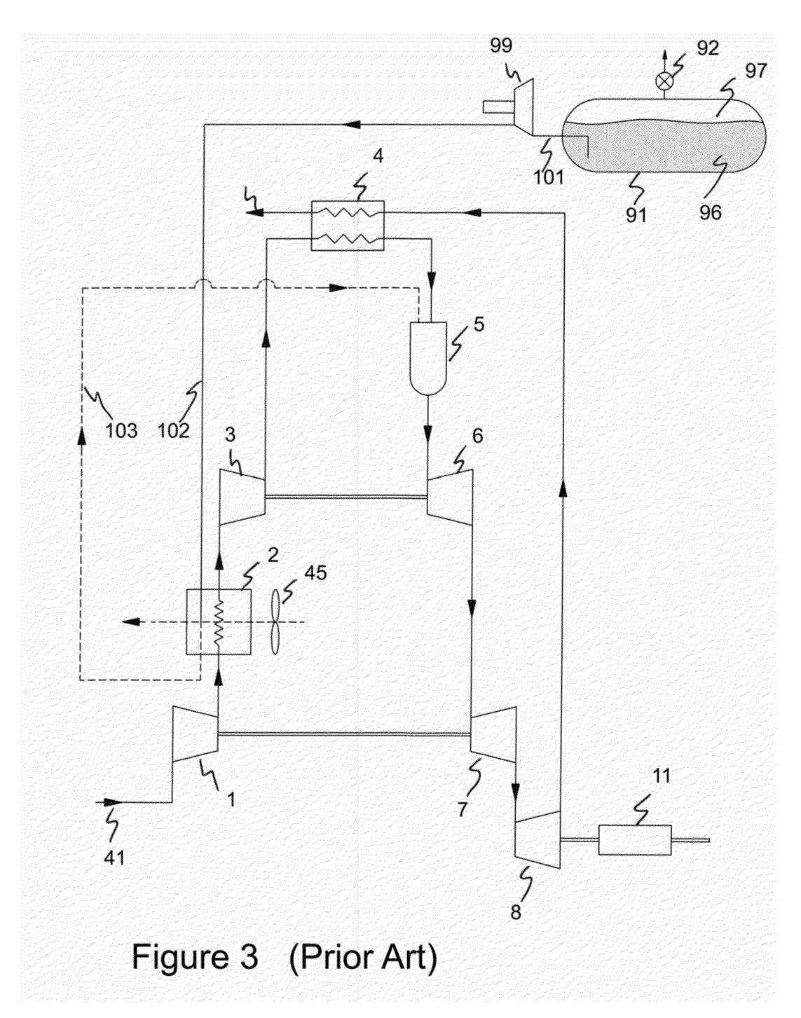

FIG. 3 is a prior art schematic representation for heating a fuel using an integrated intercooler of a gas turbine engine. In this configuration, liquid natural gas 96 is pumped through an intercooler 2 exchanging heat with the compressed air stream between the low-pressure compressor 1 and high-pressure compressor 3. The absorption of heat between the two compressors is thermodynamically beneficial to the cycle and may reduce the size of the conventional intercooler. Furthermore, it is often preferable to deliver fuel in its gaseous phase to the combustor rather than in its liquid phase. Even furthermore, the low pressure compressor 1 discharge temperature is a favorable temperature to serve as a vaporizer which is not too hot, thus simplifying controls. This figure shows the same engine components as described in FIG. 2 but with the addition of a modified intercooler in the path of the fuel stream. Liquid natural gas is pumped as shown by path 101 from tank 91 through a cryogenic booster pump 99, from booster pump 99 as a liquid to intercooler 2 via path 102 and from intercooler 2, where it is substantially vaporized, to combustor 5 as a gas via path 103. LNG tank 91 contains mainly liquid natural gas 96 and natural gas vapor 97 and includes a safety pressure vent valve 92.

It is estimated that when LNG fuel is used to enhance cooling, the intercooler exit temperature can be lowered by about 21 degrees F. as compared to the non-enhanced intercooler. The effect of additional pre-cooling of the main air flow at the inlet of the high pressure compressor by about 21 F, as estimated using a gas turbine simulation technique, shows that engine efficiency is increased by just over about 1.2% to about 44.4% when the input air flow is slightly reduced to maintain an approximately constant output shaft power. This efficiency is an increase from its baseline efficiency of about 43.2% (natural gas fuel injected at 298 K). In this estimate, there is some heating of the fuel beyond ambient temperature of about 298 K to about 410 K.

This figure was disclosed in U.S. patent application Ser. No. 13/281,702 entitled “Utilizing Heat Discarded from a Gas Turbine Engine” filed Oct. 26, 2011.

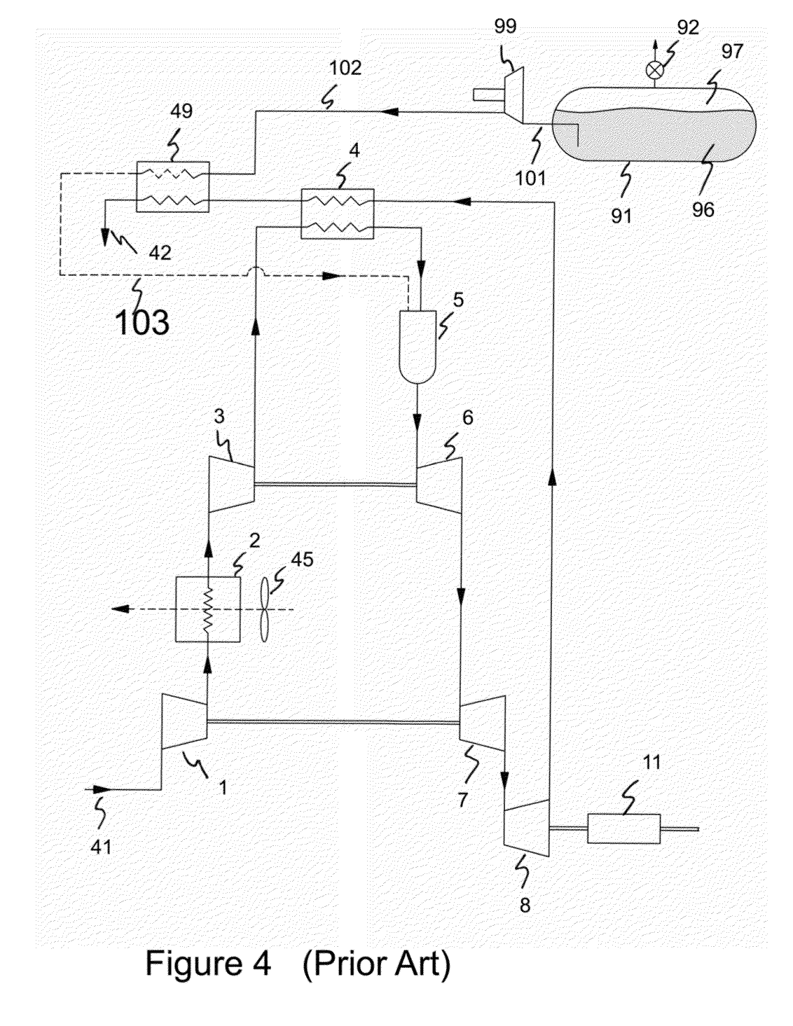

FIG. 4 is a prior art schematic representation for heating a fuel using the exhaust heat energy of a gas turbine engine to transform the liquid to gas phase and further heat the fuel. This solution provides a thermodynamic benefit to the engine cycle by using otherwise waste heat to help raise the temperature of the fuel to a level where the energy required to bring the fuel to injection temperature is minimized. This figure shows the same engine components as described in FIG. 4 but with the liquid fuel being vaporized by an exhaust heat exchanger or heat jacket 49. Liquid natural gas 96 is pumped with a cryogenic booster pump 99 through a valve from LNG tank 91 to heat exchanger 49 where it is substantially vaporized. The resulting natural gas vapor is then injected into combustor 5. Liquid natural gas is pumped as shown by path 101 from tank 91 through booster pump 99, from booster pump 99 as a liquid to the cold side of heat exchanger 49 via path 102 and from heat exchanger 49 to combustor 5 as a gas via path 103. Hot engine exhaust gases from the hot side of recuperator 4 are directed through the hot side of heat exchanger 49 where thermal energy is transferred to the cold side of heat exchanger 49 to substantially vaporize the LNG fuel stream. LNG tank 91 contains mainly liquid natural gas 96 and natural gas vapor 97 and includes a safety pressure vent valve 92.

In the configuration of FIG. 4, the LNG is assumed to be stored at approximately 100 K. If the LNG were heated by a heat exchanger using the heat of the exhaust gases such as illustrated in FIG. 4, then a practical sized heat exchanger can be used to deliver methane vapor to the combustor at about 700 K. This would increase the overall thermal efficiency of the engine by about 1% from its baseline efficiency of about 43.2% (natural gas fuel injected at 298 K) to about 44.2%.

The use of the hot exhaust gases to heat a fuel stream prior to injection to a combustor can be applied to any gaseous or liquid fuel from those stored at cryogenic temperatures to those stored at room temperature or higher. As long as the fuel is stored at a temperature below the exhaust gas temperature, some pre-heating of the fuel and some increase in thermal efficiency of the engine can be obtained.

The heat exchanger to capture heat from the exhaust gases may be a heat jacket around a section of the exhaust pipe. A simple heat jacket is practical because the mass of cold fluid (fuel) is small compared to the mass of hot fluid (combustion products). In the above examples the mass of fuel is typically about 18 grams and the mass of combustion products is about 1.2 kg.

This figure was also disclosed in U.S. patent application Ser. No. 13/281,702.

### PRESENT DISCLOSURE

LNG storage vessels, reliant solely on insulation, are subject to increased vapor pressure as the two-phase fluid bulk temperature rises. When the pressure reaches the vessel safety set point (typically about 250 psi), a safety vent must open to relieve the pressure.

Engines which pump or aspirate the vapor phase to the fuel injectors lower the vapor pressure and thereby cause boiling at the liquid-vapor interface. This boiling or phase change is endothermic, causing the bulk mixture temperature to drop. For this reason, fuel vapor aspirated engines are able to extend the onboard fuel storage period.

Engines which pump the liquid phase to the fuel injectors do not substantially lower the tank pressure or temperature when consuming fuel.

A gas turbine engine, with its combustion chamber operating as high as about 230 psig at full power, would appear to need a liquid pump and fueling system. Such an engine is described, for example, in U.S. patent application Ser. No. 12/115,134 entitled “Multi-Spool Intercooled Recuperated Gas Turbine” filed May 5, 2008; U.S. patent application Ser. No. 13/175,564 entitled “Improved Multi-Spool Intercooled Recuperated Gas Turbine” filed Jul. 1, 2011; and U.S. patent application Ser. No. 13/226,156 entitled “Gas Turbine Engine Configurations” filed Sep. 6, 2011.

One characteristic of this engine is that its combustion chamber pressure varies widely over its operating range, such that at times its pressure may be well below the vapor pressure of the LNG vessel. Certainly during starting, the engine combustion chamber pressure is lower than the LNG vapor pressure.

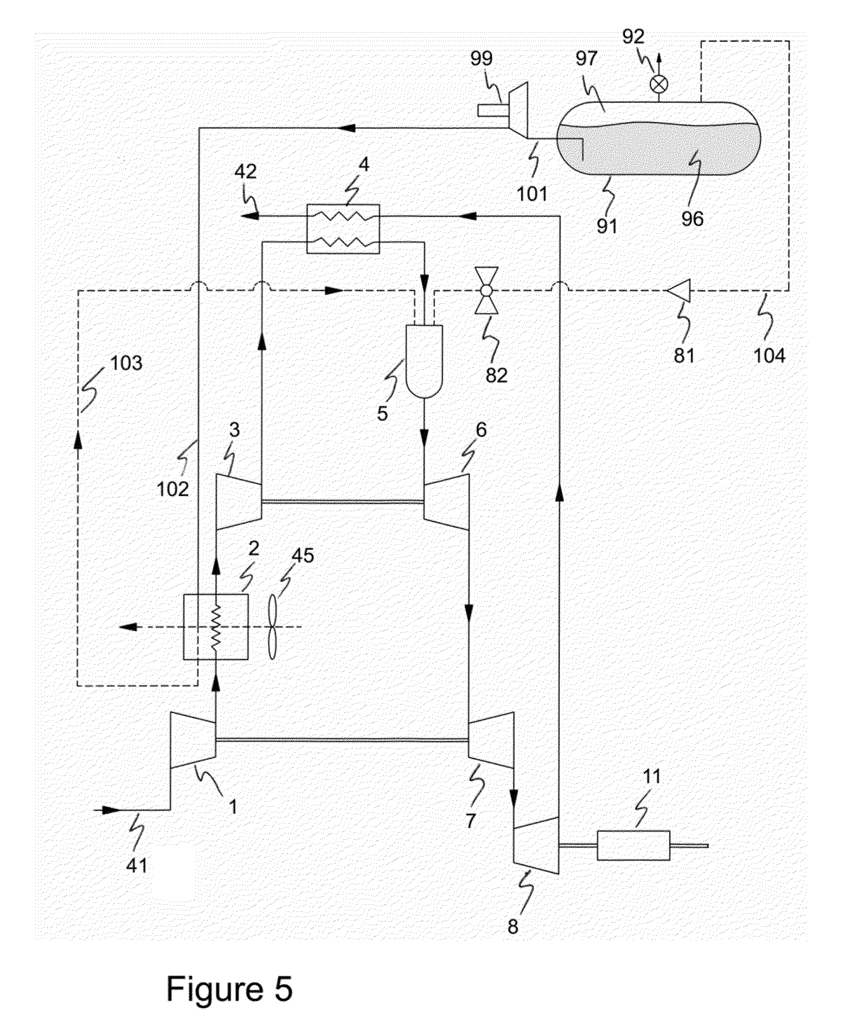

FIG. 5 is schematic representation for a method of controlling LNG vapor as a primary fuel and heating a liquid fuel using an integrated intercooler of a gas turbine engine. This intercooled, recuperated gas turbine engine is shown in FIG. 5 with an LNG tank 91 and intercooler 2 and two parallel fuel paths. This configuration incorporates a liquid-to-vapor LNG fuel circuit (paths 101, 102 and 103) in parallel with a vapor fuel circuit (path 104). The two parallel fuel circuits are in operational mode for the most part both continuously and simultaneously. The vapor circuit 104 is shown with a check valve 81 and fuel control throttle valve 82. The liquid circuit includes a booster pump 99.

In operation, the vapor circuit 104 preferably has priority. Whenever an engine control unit (“ECU”) (not shown) demands fuel, vapor fuel control throttle valve 82 opens. If the vapor pressure in LNG tank 91 is greater than that of the combustion chamber 5, fuel will flow. The liquid fuel circuit (paths 101, 102 and 103) provides open-loop fuel delivery when the ECU senses that the vapor throttle valve 82 is wide open and still more fuel is required. If the vapor pressure in LNG tank 91 is less than that of the combustion chamber 5, the ECU will provide fuel via the liquid fuel circuit (paths 101, 102 and 103) only.

The ECU can control vapor circuit fuel control throttle valve 82 and liquid circuit booster pump 99 by software or firmware using a computer readable medium. Alternately, the ECU can control the fuel circuits by mechanical means.

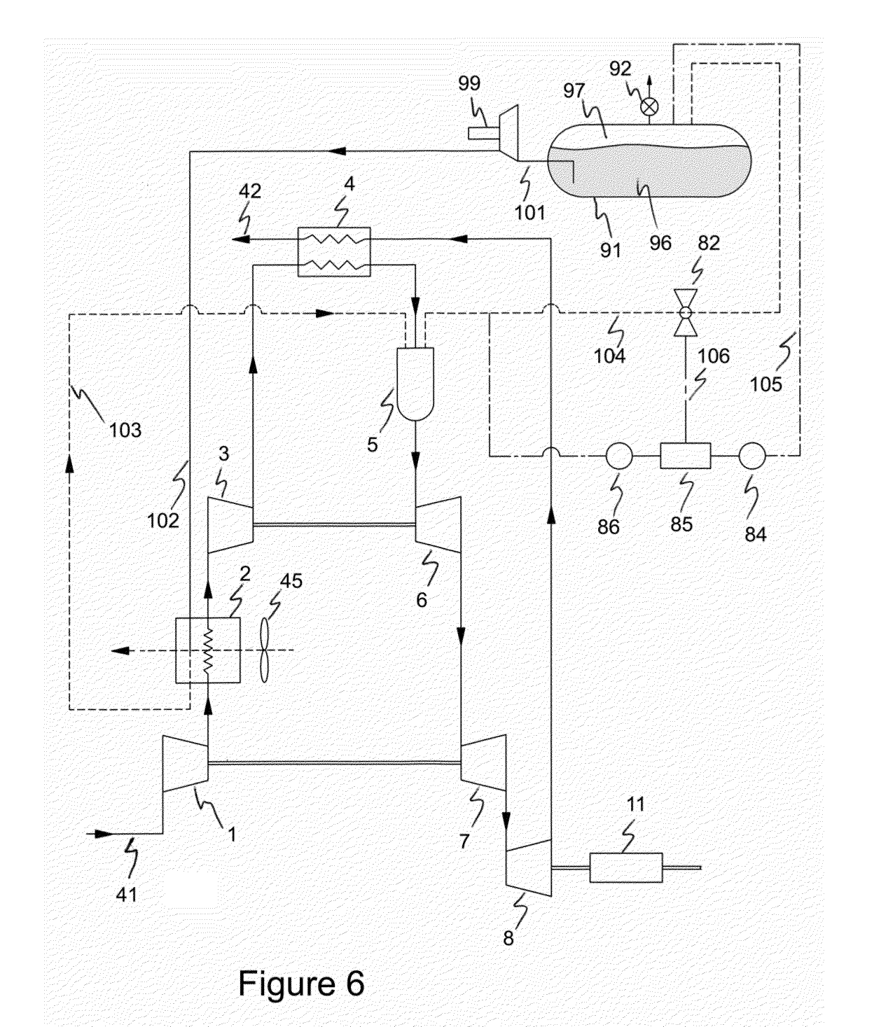

FIG. 6 is schematic representation for an alternate method of controlling LNG vapor as a primary fuel in a gas turbine engine. As in the configuration of FIG. 5, the liquid fuel is heated and vaporized using an integrated intercooler. This intercooled, recuperated gas turbine engine is shown in FIG. 6 with an alternate configuration of vapor fuel circuit 104 in parallel with a liquid-to-vapor LNG fuel circuit (paths 101, 102 and 103). The two parallel fuel circuits are in operational mode for the most part both continuously and simultaneously. The vapor circuit 104 is shown with a fuel control throttle valve 82. Valve 82 is controlled by ECU 85 which senses the vapor pressure in LNG tank 91 with pressure sensor 84 as well as combustor 5 inlet gas pressure with pressure sensor 86. Only the liquid circuit includes a booster pump 99. A benefit of this configuration is that the parallel fuel delivery system allows vapor pressure build-up in the fuel tank to be more effectively managed than by simply allowing vapor pressure to build up and then vent the over-pressure to the atmosphere.

In operation, the vapor circuit 104 preferably has priority. Whenever ECU 85 demands fuel, it opens fuel control throttle valve 82 to dispense the requested amount of fuel. If the vapor pressure in LNG tank 91 as determined by pressure sensor 84 is greater than that of the combustion chamber 5 as determined by pressure sensor 86, fuel will flow. When the ECU senses that the vapor throttle valve 82 is wide open and still more fuel is required, the liquid fuel circuit (paths 101, 102 and 103) provides additional fuel delivery. If the vapor pressure in LNG tank 91 is sensed to be less than that of the combustion chamber 5, the ECU will provide fuel via the liquid fuel circuit (paths 101, 102 and 103) only.

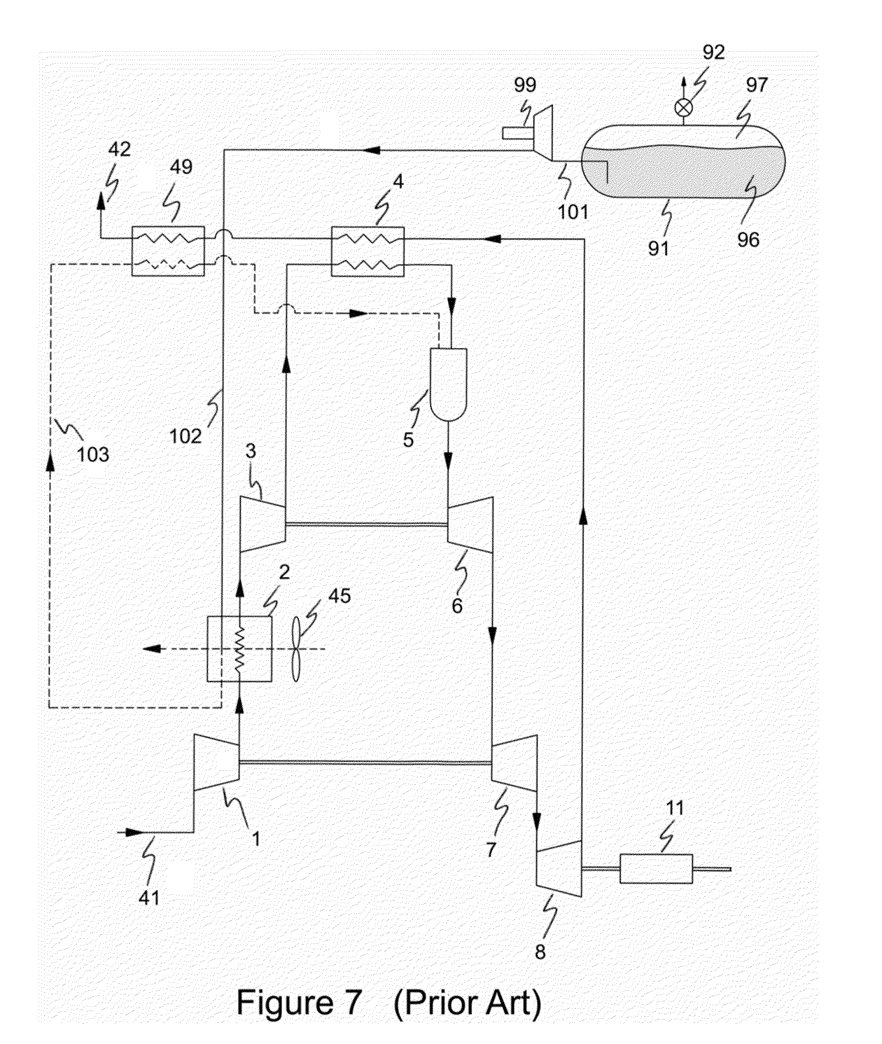

FIG. 7 is a prior art schematic representation for heating a fuel using an integrated intercooler and a heat exchanger on the exhaust stream of a gas turbine engine. If liquid LNG fuel is passed thru an intercooler vaporizer such as shown in FIG. 3 and then through an exhaust heat exchanger such as shown in FIG. 4, the fuel can be heated to approximately 745 K which is about 35 K cooler than the output of the hot side of the recuperator. In this case there is an increase in thermal efficiency of about 2.15% over the full power thermal efficiency of the baseline engine performance. The efficiency of this configuration is estimated to be about 45.3% (compared to baseline efficiency of 43.18%) when the input air flow is slightly reduced to maintain an approximately constant output shaft power. In this configuration, there is no power penalty for heating LNG to room temperature. There is a thermodynamic advantage from cooling the outlet air from the intercooler and a further thermodynamic advantage from heating the fuel from ambient temperature to nearly the output temperature of the hot side of the recuperator. To gain these advantages, an exhaust heat exchanger is required and a modified intercooler system is required. These are not large heat exchangers as the mass of cold fluid (fuel) is small compared to the mass of hot fluid (air or combustion products). In the above examples the mass of fuel is typically about 18 grams and the mass of inlet air or combustion products is about 1.2 kg.

This configuration was discussed in U.S. patent application Ser. No. 13/281,702.

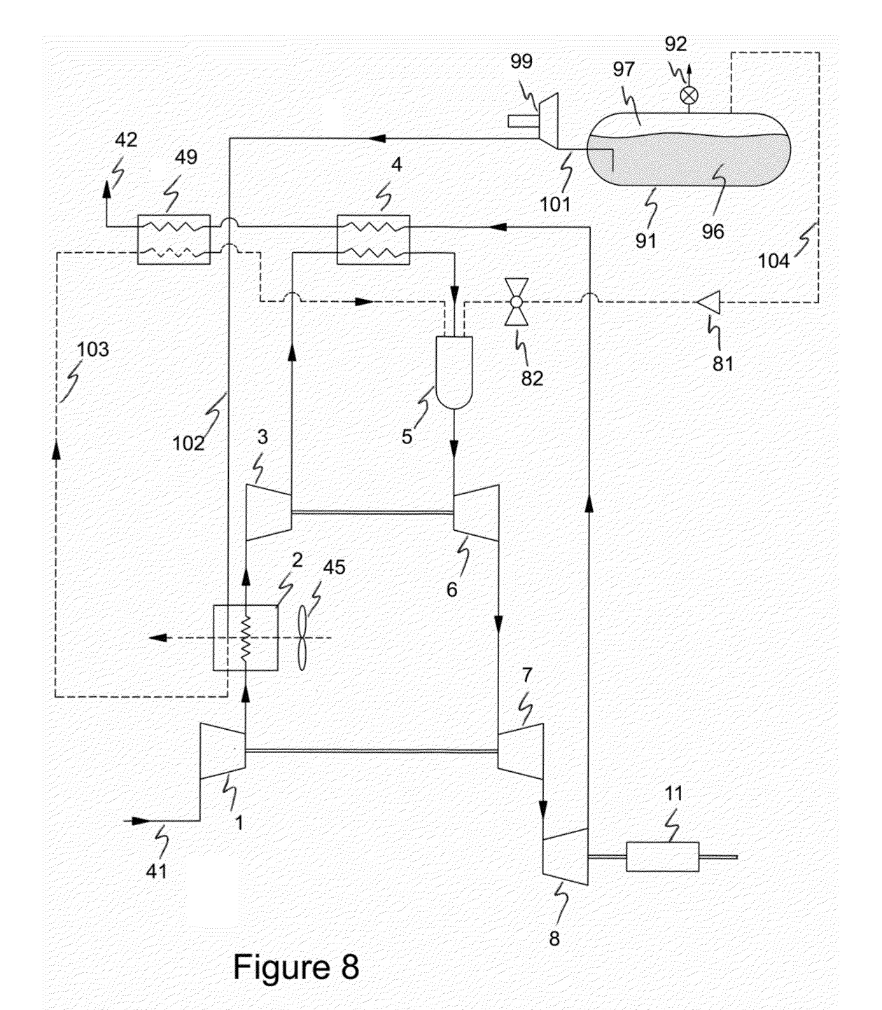

FIG. 8 is schematic representation for a method of controlling LNG vapor as a primary fuel and heating a liquid fuel using an integrated intercooler and a heat exchanger on the exhaust stream of a gas turbine engine. The configuration shown in FIG. 8 combines the vapor fuel circuit 104 of FIG. 5 with the liquid fuel circuit (paths 101, 102 and 103) comprising an integrated intercooler and a heat exchanger on the exhaust stream as shown in FIG. 7. The configuration and operation of FIG. 8 is identical to the configuration and operation of FIG. 5 except that the vaporized liquid fuel is further heated by a heat exchanger or heat jacket on the exhaust stream as shown in FIG. 7.

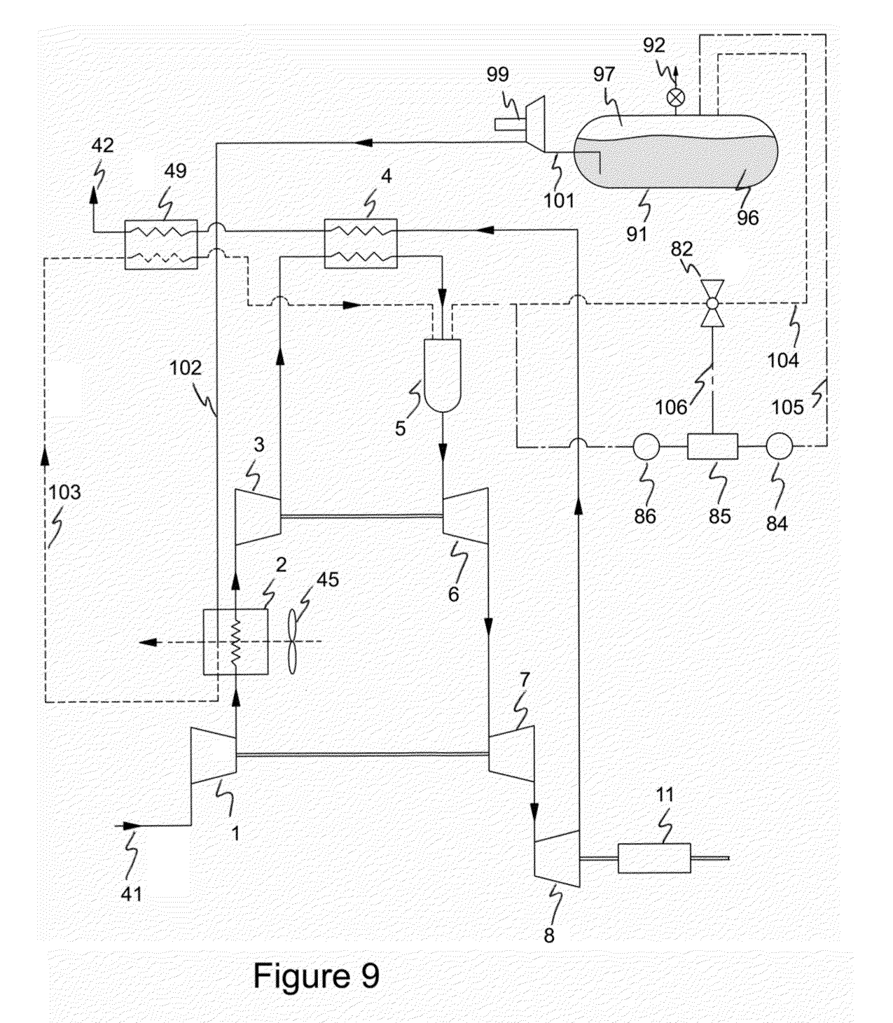

FIG. 9 is schematic representation for an alternate method of controlling LNG vapor as a primary fuel and heating a liquid fuel using an integrated intercooler and a heat exchanger on the exhaust stream of a gas turbine engine. FIG. 9 combines the vapor fuel circuit 104 of FIG. 6 with the liquid fuel circuit (paths 101, 102 and 103) comprising an integrated intercooler and a heat exchanger on the exhaust stream as shown in FIG. 7. The configuration and operation of FIG. 9 is identical to the configuration and operation of FIG. 6 except that the vaporized liquid fuel is further heated by a heat exchanger or heat jacket on the exhaust stream as shown in FIG. 7.

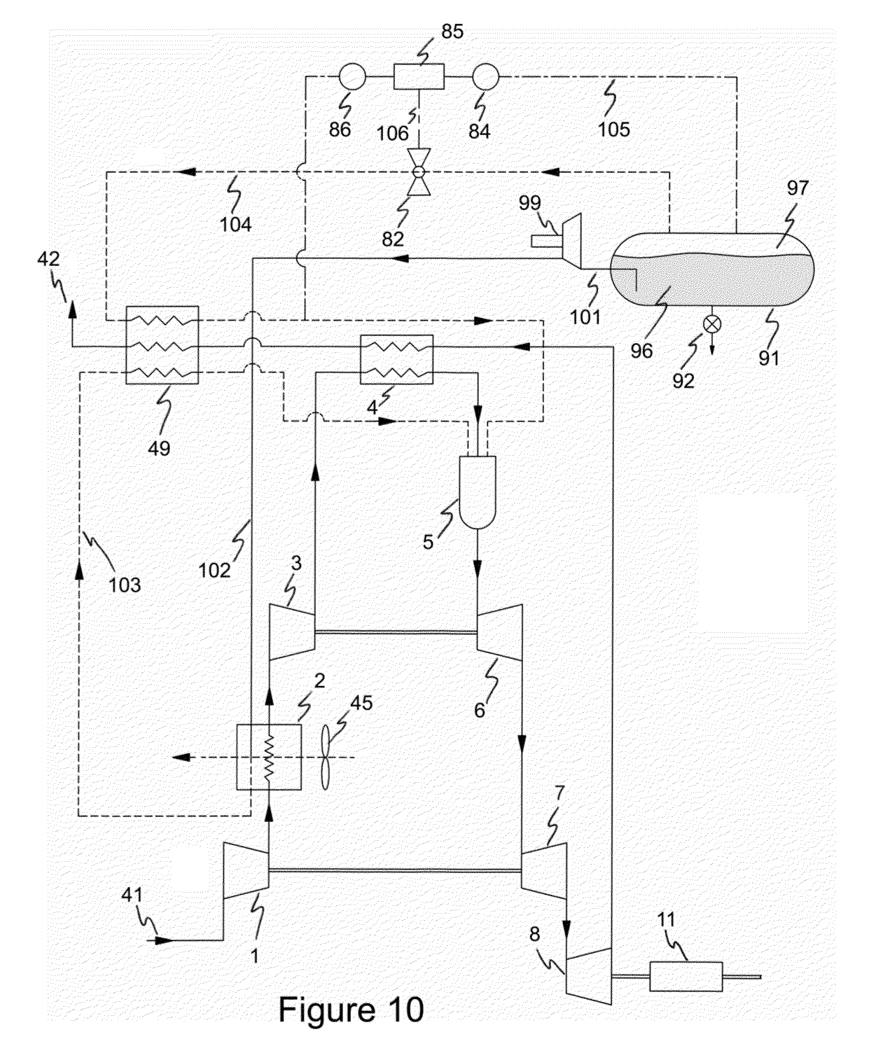

FIG. 10 is schematic representation for yet another alternate method of controlling LNG vapor as a primary fuel and heating a liquid fuel using an integrated intercooler and a heat exchanger on the exhaust stream of a gas turbine engine. FIG. 10 combines the vapor fuel circuit 104 of FIG. 6 with the liquid fuel circuit (paths 101, 102 and 103) comprising an integrated intercooler and a heat exchanger on the exhaust stream as shown in FIG. 7. In addition, FIG. 10 shows the vapor fuel circuit 104 also passing through the heat exchanger on the exhaust stream where the vapor can be further heated before being delivered to the combustor, lessening the energy required to heat the fuel for combustion. The configuration and operation of FIG. 9 is identical to the configuration and operation of FIG. 6 except that both the vaporized liquid fuel and LNG vapor fuel streams are heated by a heat exchanger or heat jacket on the exhaust stream before being injected into combustor 5.

The following Table 1 illustrates the approximate efficiency penalties for injection of LNG liquid or vapor directly into the combustion chamber of a small gas turbine engine as compared to the baseline case of methane fuel initially at 298 K. Table 1 also illustrates the approximate efficiency gain by heating and vaporizing LNG liquid by passing it through an intercooler before injection into the combustion chamber such as illustrated in FIG. 3. Table 1 then illustrates the approximate efficiency gain by heating both LNG liquid and LNG vapor fuel streams to about 745 K before injection into the combustion chamber such as illustrated in FIG. 10. A potential overall engine efficiency gain of about 2.5% is therefore possible by intelligently managing LNG fuel during engine operation and utilizing waste heat sources to heat the fuel from cryogenic conditions to temperatures approaching those of the air at the output of the hot side of the recuperator.

TABLE I
Example Engine Output Power 377 kW
Methane Fuel Flow Rate = 0.1746 kg/s

| | | Change |
|---|---|---|
| | Engine | from |
| Fuel Injection Case | Efficiency | Baseline |
| Baseline - Injection of Gaseous Methane at 298 K | 43.18% | 0.0% |
| directly into Combustor | | |
| Injection of LNG Vapor initially at 100 K directly | 42.82% | −0.36% |
| into Combustor (FIG. 1) | | |
| Injection of LNG Liquid initially at 100 K | 42.38% | −0.80% |
| directly into Combustor (FIG. 2) | | |
| Injection of LNG Liquid initially at 100 K thru | 44.4% | +1.20% |
| Intercooler then into Combustor (FIG. 3) | | |
| LNG thru Intercooler and all Fuel thru Exhaust | 45.33% | +2.15% |
| Heat Exchanger then injected into Combustor | | |
| (FIG. 10) | | |

As can be appreciated, the exhaust heat exchanger 49 may be a heat exchanger or heat jacket. The exhaust heat exchanger 49 may be separate heat exchangers or heat jackets for the liquid fuel circuit and the vapor fuel circuit. As can be further appreciated, the vapor from the liquid fuel circuit may be combined with the vapor from the vapor fuel circuit just upstream of exhaust heat exchanger 49 so as to simplify the design of exhaust heat exchanger 49.

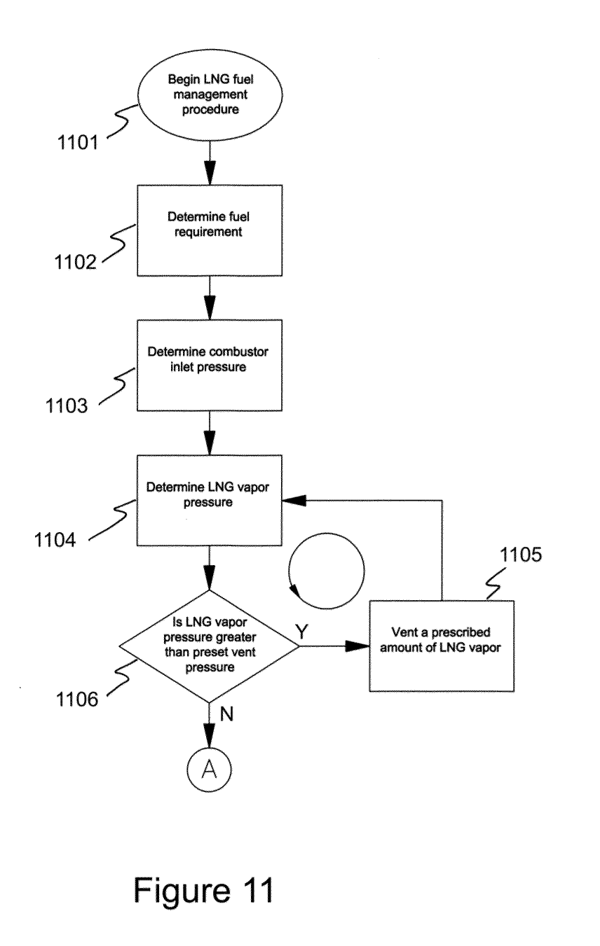

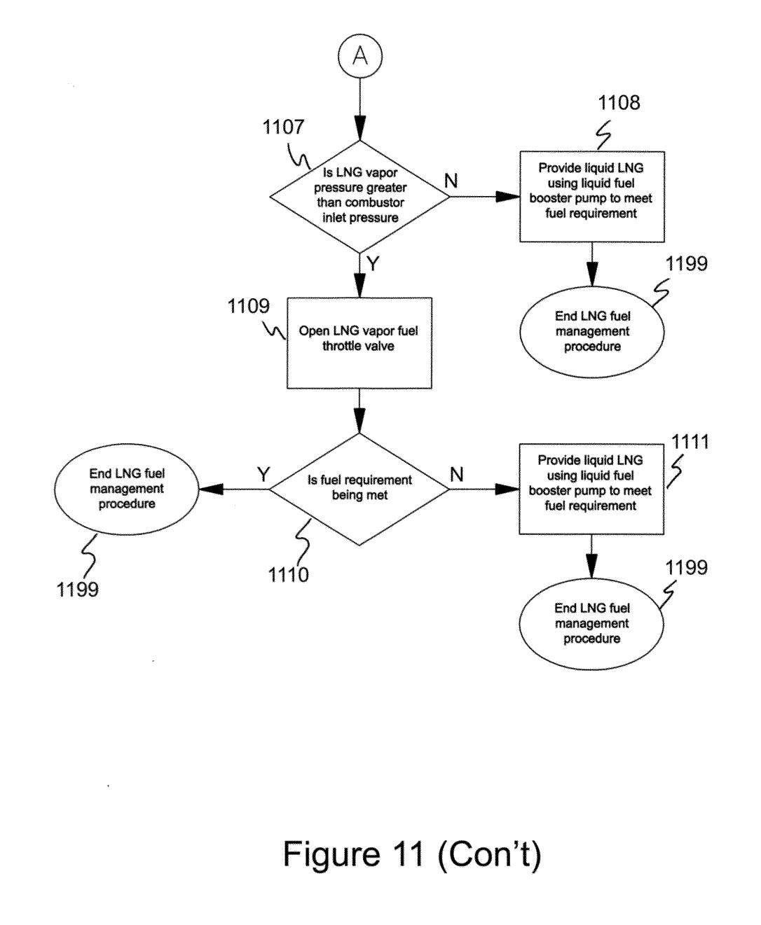

FIG. 11 is a flow chart illustrating operational logic of an LNG fuel management system wherein LNG is used as the example of a cryogenic fuel. This fuel management procedure can be implemented by an on-board computer (microprocessor) with appropriate software stored on a tangible and non-transient computer readable medium, with firmware or by an all-mechanical control system. If the fuel management procedure is implemented by an software, firmware or mechanical control, the appropriate sensors, such as for example, pressure gauges, fuel flow meters and the like would be automatically interrogated and acted on by the control system.

The fuel management system described in FIG. 11 is designed to substantially minimize venting of LNG vapor when the vapor pressure exceeds a preset venting pressure threshold. The LNG vapor in the fuel tank is preferentially used to satisfy the engine's fuel requirement and when not enough fuel can be supplied from the LNG vapor, liquid LNG is then drawn from the fuel tank. Prior to entering the combustor, the liquid LNG fuel is heated until it is vaporized. In this way, gaseous natural gas fuel is always delivered to the engine's combustor.

The fuel management procedure shown in FIG. 11 is executed and, when complete, the fuel management procedure cycle is repeated under control of an ECU. The fuel management procedure begins 1101 with a determination of fuel requirement 1102, combustor inlet pressure 1103 and vapor pressure in the LNG fuel tank 1104. In step 1106, if the LNG tank vapor pressure is greater than a prescribed level, then some LNG vapor is vented 1105 until the vapor pressure falls below the prescribed level. Once the LNG tank vapor pressure falls below the prescribed level but the vapor pressure is less than the combustor inlet pressure, then the ECU activates the LNG liquid booster pump 1108 and the engine's fuel requirement can be met by liquid LNG and the fuel management cycle is terminated 1199. If the vapor pressure is greater than the combustor inlet pressure 1107, the ECU opens the LNG vapor fuel throttle valve 1109. If the flow of LNG vapor satisfies the engine's fuel requirement 1110, then the fuel management procedure is terminated 1199. If the flow of LNG vapor cannot satisfy the engine's fuel requirement 1110, then the ECU activates the LNG liquid booster pump 1111 and the engine's fuel requirement can be met by the combination of LNG vapor and liquid LNG and the fuel management procedure is terminated 1199. As long as the engine is running, the fuel management procedure will be repeated under the control of the ECU.

As can be appreciated, the same procedure can be used for any cryogenic or volatile fuel.

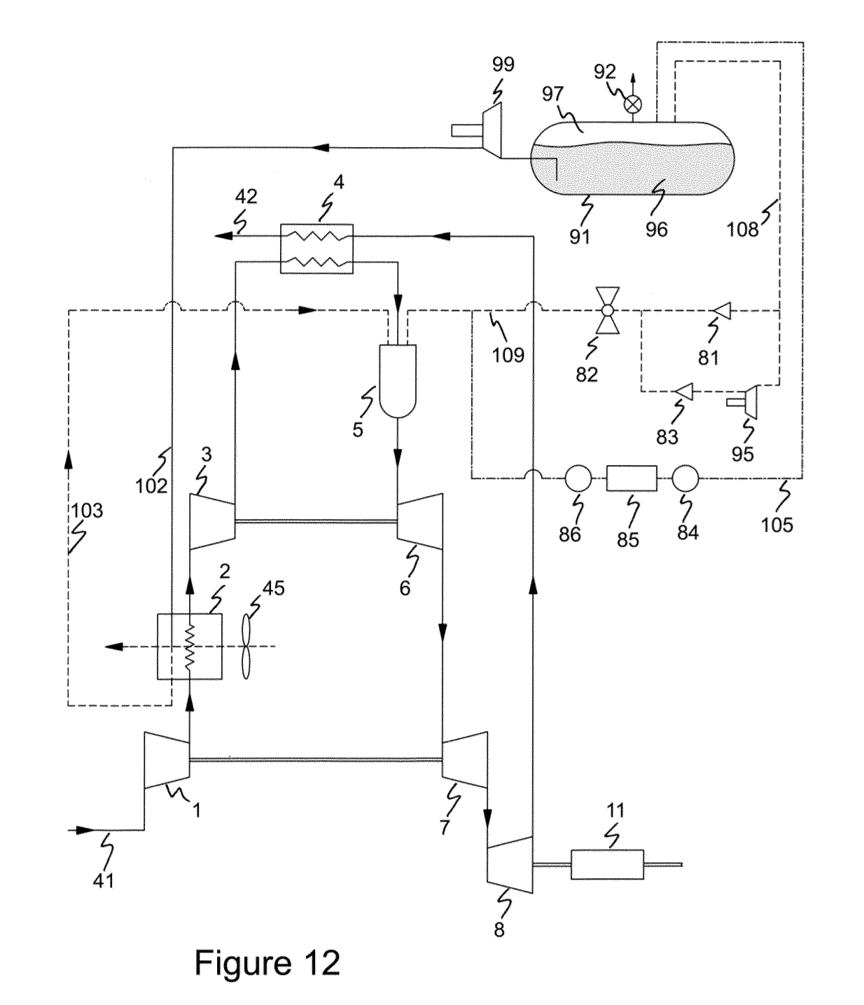

FIG. 12 is schematic representation for a method of further controlling LNG vapor pressure. This figure is similar to FIG. 6 except that the vapor fuel circuit now includes a small vapor booster pump 95 that is used when combustor inlet pressure is higher than the vapor pressure in fuel tank 91. When combustor inlet pressure is higher than the vapor pressure in fuel tank, ECU 85 can open throttle valve 82 and vapor fuel will be delivered to combustor 5 through vapor booster pump 95. Check valve 81 prevents the pressurized vapor from returning to the fuel tank.

When combustor inlet pressure is less than the vapor pressure in fuel tank 91, ECU 85 can open throttle valve 82 and vapor will flow from fuel tank 91 through check valve 81 to combustor 5. Depending on the type of vapor booster pump, some vapor may flow through the pump.

Check valves 81 and 83 prevent reverse flow of combustor gases to the fuel tank and reverse flow through booster pump 95

In operation, the vapor fuel circuit (paths 108 and 109) preferably has priority. Whenever ECU 85 demands fuel, vapor fuel control throttle valve 82 opens and vapor fuel is delivered either though check valve 81 or vapor booster pump 95. The liquid fuel circuit (paths 101, 102 and 103) provides fuel delivery when the ECU senses that the vapor throttle valve 82 is wide open and still more fuel is required.

The ECU can control vapor circuit fuel control throttle valve 82, vapor circuit booster pump 95 and liquid circuit booster pump 99 by software or firmware using a computer readable medium. Alternately, the ECU can control the fuel circuits by mechanical means such as pressure sensitive valves.

As noted previously, in vapor phase fuel delivery systems, the phase transformation from boiling serves to cool the liquid-vapor fuel mixture, thereby preventing or delaying the need to vent fuel vapor. The system illustrated in FIG. 12 is designed to allow the vapor pressure in the fuel tank to be held at any vapor pressure between about atmospheric pressure and the preset venting pressure while the engine is operative irrespective of the combustor inlet pressure. For example, the vapor pressure in the fuel tank can be maintained at or near atmospheric pressure while the engine is operative so as to maximize cooling due to transformation from the liquid phase to the vapor phase. Then, no matter when the engine is shut down, the time before vapor pressure can build up due to heat transfer through the insulated fuel tank walls and exceed the preset vent pressure threshold causing the vapor to be vented the fuel tank will be maximized. Alternately, the vehicle operator can run the engine on liquid phase and only activate the vapor fuel circuit when the preset vent pressure threshold is approached or when he is preparing to shut down the engine.

As can be appreciated, the same procedure can be used for any cryogenic or volatile fuel.

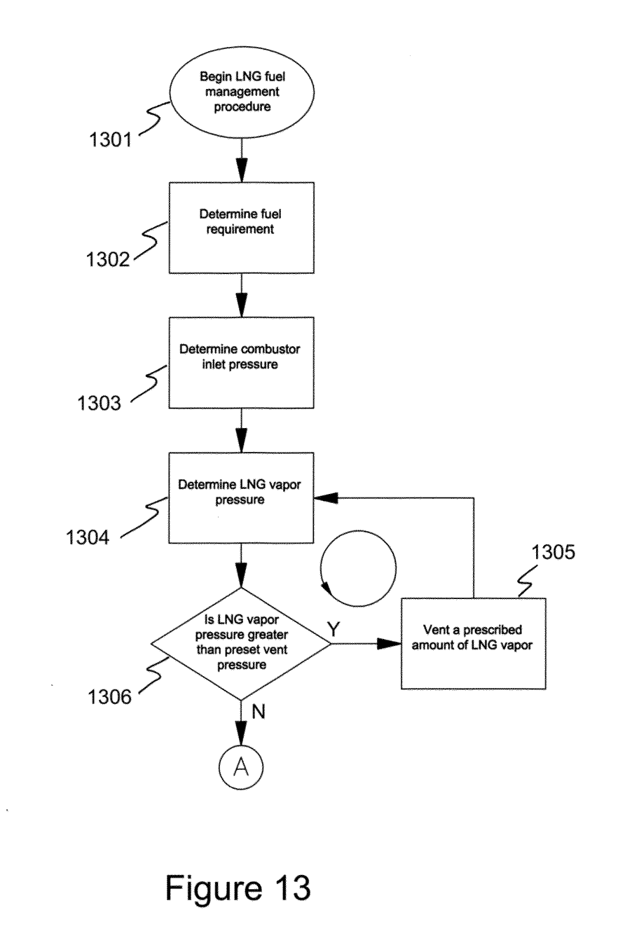

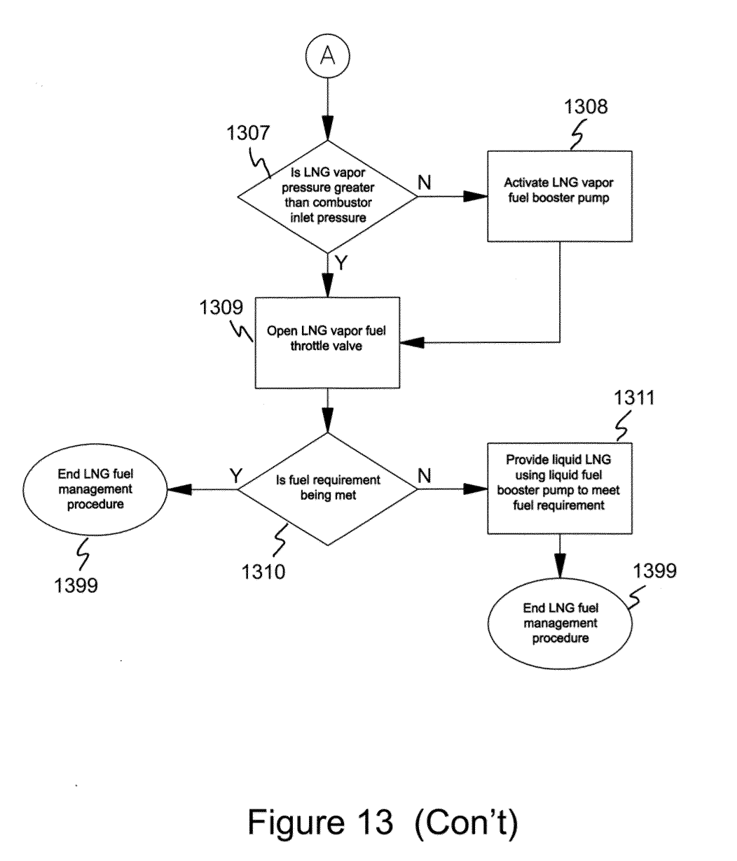

FIG. 13 is a flow chart illustrating an LNG fuel management for the configuration shown in FIG. 12 wherein LNG is used as the example of a cryogenic fuel. This fuel management procedure can be implemented by an on-board computer (microprocessor) with appropriate software stored on a tangible and non-transient computer readable medium, with firmware or by an all-mechanical control system. If the fuel management procedure is implemented by an software, firmware or mechanical control, the appropriate sensors, such as for example, pressure gages, fuel flow meters and the like would be automatically interrogated and acted on by the control system.

The fuel management system described in FIG. 13 is designed to substantially minimize venting of LNG vapor when the vapor pressure exceeds a preset venting pressure threshold. This fuel management system is further designed to maximize the time delay before the LNG vapor pressure reaches the preset vent pressure. The LNG vapor in the fuel tank is preferentially used to satisfy the engine's fuel requirement and when not enough fuel can be supplied from the LNG vapor, liquid LNG is then drawn from the fuel tank. Prior to entering the combustor, the liquid LNG fuel is heated until it is vaporized. In this way, gaseous fuel is always delivered to the engine's combustor.

The fuel management procedure shown in FIG. 13 is executed and, when complete, the fuel management cycle is repeated under control of an ECU. The fuel management procedure begins 1301 with a determination of fuel requirement 1302, combustor inlet pressure 1303 and vapor pressure in the LNG fuel tank 1304. In step 1306, if the LNG tank vapor pressure is greater than a prescribed level, then some LNG vapor is vented 1305 until the vapor pressure falls below the prescribed level. Once the LNG tank vapor pressure falls below the prescribed level but the vapor pressure is less than the combustor inlet pressure, then the ECU activates the LNG vapor booster pump 1308 and opens the LNG vapor fuel throttle valve 1309. Alternately, if the vapor pressure in the fuel tank is greater than the combustor inlet pressure 1307, the ECU does not activate the vapor booster pump but simply opens the LNG vapor fuel throttle valve 1309. If the flow of LNG vapor satisfies the engine's fuel requirement 1310, then the fuel management procedure is terminated 1399. If the flow of LNG vapor cannot satisfy the engine's fuel requirement 1310, then the ECU activates the LNG liquid booster pump 1311 and the engine's fuel requirement can be met by the combination of LNG vapor and liquid LNG and the fuel management procedure is terminated 1399. As long as the engine is running, the fuel management procedure will be repeated under the control of the ECU.

As can be appreciated, the same procedure can be used for any cryogenic or volatile fuel.

The disclosures presented herein may be used on gas turbine engines used in vehicles or in gas turbine engines used in stationary applications such as, for example, power generation and gas compression.

The exemplary systems and methods of this disclosure have been described in relation to preferred aspects, embodiments, and configurations. Modifications and alterations will occur to others upon a reading and understanding of the preceding detailed description. It is intended that the disclosure be construed as including all such modifications and alterations insofar as they come within the scope of the appended claims or the equivalents thereof. To avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

The disclosure has been described with reference to the preferred embodiments. Modifications and alterations will occur to others upon a reading and understanding of the preceding detailed description. It is intended that the disclosure be construed as including all such modifications and alterations insofar as they come within the scope of the appended claims or the equivalents thereof.

A number of variations and modifications of the disclosures can be used. As will be appreciated, it would be possible to provide for some features of the disclosures without providing others.

The present disclosure, in various embodiments, includes components, methods, processes, systems and/or apparatus substantially as depicted and described herein, including various embodiments, sub-combinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover though the description of the disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An engine, comprising:
a combustor operable to combust a fuel and air mixture capable of performing work;
a first fuel path from a vessel containing a fuel comprised of at least two phases, to the combustor to convey a first portion of the fuel from the fuel-containing vessel to the combustor; and
a separate second fuel path from the fuel-containing vessel to convey a second portion of the fuel from the fuel-containing vessel to the combustor;
wherein, in the fuel-containing vessel, at least most of the first portion is in a different phase than at least most of the second portion and wherein a common fuel-containing vessel contains both the first and second portions and is in fluid communication with the first and second fuel paths.

2. The engine of claim 1, wherein the second portion of the fuel is selected when at least one of the following is true: (a) the pressure of the first portion of the fuel is outside a selected pressure range and (b) the first portion of the fuel is less than the amount of fuel required by the combustor.

3. The engine of claim 1, wherein the first portion of the fuel is substantially in a vapor phase when removed from the fuel-containing vessel and the second portion of the fuel is substantially in a liquid phase when removed from the fuel-containing vessel.

4. The engine of claim 1, wherein the first fuel path comprises a fuel throttle valve that, in a first mode, opens when the combustor requires fuel and the fuel flow is towards the combustor and, in a second mode, closes when the combustor does not require fuel.

5. The engine of claim 4, wherein, in the first mode, the first portion of the fuel flows to the combustor when a vapor pressure in the vessel is greater than a gas pressure in the combustor, wherein, in the second mode, the first portion of the fuel flows to the combustor when a pump in fluid communication with the first fuel path is available and wherein, in the third mode, the second portion of the fuel is provided to the combustor when the first portion of the fuel fails to satisfy a fuel requirement of the combustor.

6. The engine of claim 5, wherein a pump in fluid communication with the second fuel path causes the second portion of the fuel to be provided to the combustor in response to a combustor fuel requirement being unmet by the first portion of the fuel and wherein the first portion is a natural gas in the vapor phase and the second portion of the fuel is a natural gas in the liquid phase.

7. The engine of claim 1, wherein, during a first time interval, the combustor receives only the first portion of the fuel, wherein, during a second time interval, the combustor receives only the second portion of the fuel, and wherein, during a third time interval, the combustor receives both the first and second portions of the fuel simultaneously.

8. The engine of claim 1, further comprising:
at least first and second turbo-compressor spools, each of the at least first and second turbo-compressor spools comprising a compressor in mechanical communication with a corresponding turbine, and wherein the work is performed by combustor reaction products output by the combustor driving the first and second turbo-compressor spools.

9. The engine of claim 8, wherein each of the at least first and second turbo-compressor spools output an exhaust gas and further comprising at least one of:
an intercooler positioned in a compressed gas flow path between the compressors of the first and second turbo-compressor spools operable to transfer a portion of thermal energy in the compressed gas compressed by one of the compressors to at least one of the first and second portions of the fuel prior to introduction into the combustor; and
an exhaust heat exchanger positioned downstream of the turbines in the first and second turbo-compressor spools to transfer a portion of thermal energy in the exhaust gas to at least one of the first and second portions of the fuel prior to introduction into the combustor.

10. The engine of claim 1, further comprising:
a first pressure sensor operable to sense a vapor pressure in the fuel-containing vessel;
a second pressure sensor operable to sense a vapor pressure at a combustor inlet; and;
an electronic control unit operable to apply the following rules:
when the combustor requires fuel and the pressure sensed by the first pressure sensor exceeds the pressure sensed by the second pressure sensor, open a fuel control throttle valve to enable the first portion of the fuel to flow from the fuel-containing vessel to the combustor;
when the combustor requires fuel and the pressure sensed by the first pressure sensor is less than the pressure sensed by the second pressure sensor and a pump in fluid communication with the first fuel path is not available, not open the fuel control throttle valve and enable the second portion of the fuel to flow from the fuel-containing vessel to the combustor;
when the combustor requires fuel and the pressure sensed by the first pressure sensor is less than the pressure sensed by the second pressure sensor and a pump in fluid communication with the first fuel path is available, activate the pump in fluid communication with the first fuel path and open a fuel control throttle valve to enable the first portion of the fuel to flow from the fuel-containing vessel to the combustor; and
when the first portion of the fuel fails to satisfy a fuel requirement of the combustor, enable the second portion of the fuel to flow from the fuel-containing vessel to the combustor to satisfy the fuel requirement of the combustor.

11. A method, comprising:
combusting, by a combustor, a fuel and air mixture to perform work;
conveying, by a first fuel path from a fuel-containing vessel to the combustor, a first portion of the fuel in the fuel-containing vessel; and
conveying, by a second fuel path from the fuel-containing vessel to the combustor, a second portion of the fuel in the fuel-containing vessel, wherein a common fuel-containing vessel contains both the first and second portions of the fuel and is in fluid communication with both the first and second fuel paths.

12. The method of claim 11, wherein the first portion of the fuel is substantially in a vapor phase when removed from the fuel-containing vessel and the second portion of the fuel is substantially in a liquid phase when removed from the fuel-containing vessel.

13. The method of claim 11, wherein the first fuel path comprises a fuel throttle valve, wherein the fuel throttle control valve opens when the combustor requires fuel, and wherein the fuel throttle control valve closes when the combustor does not require fuel.

14. The method of claim 13, wherein, in a first mode, the first portion of the fuel flows to the combustor when a vapor pressure in the vessel is greater than a gas pressure in the combustor, wherein, in a second mode, the first portion of the fuel flows to the combustor when a vapor pressure in the vessel is less than a gas pressure in the combustor and when a pump in fluid communication with the first fuel path is available, and wherein, in a third mode, the second portion of the fuel is provided to the combustor when the first portion of the fuel fails to satisfy a fuel requirement of the combustor.

15. The method of claim 14, wherein a pump in fluid communication with the second fuel path causes the second portion of the fuel to be provided to the combustor in response to a combustor fuel requirement being unmet by the first portion of the fuel and wherein the first portion is a natural gas in the vapor phase and the second portion of the fuel is a natural gas in the liquid phase.

16. The method of claim 11, wherein, during a first time interval, the combustor receives only the first portion of the fuel, wherein, during a second time interval, the combustor receives only the second portion of the fuel, and, during a third time interval, the combustor receives only the first and second portions of the fuel simultaneously.

17. The method of claim 11, wherein the combustor is in fluid communication with at least first and second turbo-compressor spools, each of the at least first and second turbo-compressor spools comprising a compressor in mechanical communication with a corresponding turbine and wherein the work is performed by combustor reaction products output by the combustor driving the first and second turbo-compressor spools.

18. The method of claim 17, wherein each of the at least first and second turbo-compressor spools output an exhaust gas and further comprising at least one of:
transferring, by an intercooler positioned in a compressed gas flow path between the compressors of the first and second turbo-compressor spools, a portion of thermal energy in the compressed gas compressed by one of the compressors to at least one of the first and second portions of the fuel prior to introduction into the combustor; and
transferring, by an exhaust heat exchanger positioned downstream of the turbines in the first and second turbo-compressor spools, a portion of thermal energy in the exhaust gas to at least one of the first and second portions of the fuel prior to introduction into the combustor.

19. The method of claim 11, further comprising:
sensing, by a first pressure sensor, a vapor pressure in the fuel-containing vessel;
sensing, by a second pressure sensor, a vapor pressure at a combustor inlet; and
applying, by an electronic control unit, at least the following rules:
when the combustor requires fuel and the pressure sensed by the first pressure sensor exceeds the pressure sensed by the second pressure sensor, opening a fuel control throttle valve to enable the first portion of the fuel to flow from the fuel-containing vessel to the combustor;
when the combustor requires fuel and the pressure sensed by the first pressure sensor is less than the pressure sensed by the second pressure sensor and a pump in fluid communication with the first fuel path is not available, not opening the fuel control throttle valve and enabling the second portion of the fuel to flow from the fuel-containing vessel to the combustor;
when the combustor requires fuel and the pressure sensed by the first pressure sensor is less than the pressure sensed by the second pressure sensor and a pump in fluid communication with the first fuel path is available, activating the pump in fluid communication with the first fuel path and opening a fuel control throttle valve to enable the first portion of the fuel to flow from the fuel-containing vessel to the combustor; and
when the first portion of the fuel fails to satisfy a fuel requirement of the combustor, enabling the second portion of the fuel to flow from the fuel-containing vessel to the combustor to satisfy a fuel requirement of the combustor.

20. A tangible and non-transient computer readable medium, comprising microprocessor executable instructions that, when executed, perform at least the following operations:
conveying, by a first fuel path from a fuel-containing vessel to a combustor, a first portion of the fuel in the fuel-containing vessel, wherein the combustor combusts a mixture of the fuel and air to perform work; and
conveying, by a second fuel path from the fuel-containing vessel to the combustor, a second portion of the fuel in the fuel-containing vessel, wherein a common fuel-containing vessel contains both the first and second portions of the fuel and is in fluid communication with the first and second fuel paths.

21. The computer readable medium of claim 20, wherein the first portion of the fuel is substantially in a vapor phase when removed from the fuel-containing vessel and the second portion of the fuel is substantially in a liquid phase when removed from the fuel-containing vessel.

22. The computer readable medium of claim 20, wherein the first fuel path comprises a fuel throttle valve, wherein the fuel throttle control valve opens when the combustor requires fuel, and wherein the fuel throttle control valve closes when the combustor does not require fuel.

23. The computer readable medium of claim 22, wherein the first portion of the fuel flows to the combustor when a vapor pressure in the vessel is at least one of greater than a gas pressure in the combustor and less than a gas pressure at the output of a vapor booster pump and wherein the second portion of the fuel is provided to the combustor when the first portion of the fuel fails to satisfy a fuel requirement of the combustor.

24. The computer readable medium of claim 23, wherein a pump in fluid communication with the second fuel path causes the second portion of the fuel to be provided to the combustor in response to a combustor fuel requirement being unmet by the first portion of the fuel and wherein the first portion is a natural gas in the vapor phase and the second portion of the fuel is a natural gas in the liquid phase.

25. The computer readable medium of claim 20, wherein, during a first time interval, the combustor receives only the first portion of the fuel, wherein, during a second time interval, the combustor receives only the second portion of the fuel, and wherein, during a third time interval, the combustor receives both the first and second portions of the fuel simultaneously.

26. The computer readable medium of claim 20, wherein the combustor is in fluid communication with at least first and second turbo-compressor spools, each of the at least first and second turbo-compressor spools comprising a compressor in mechanical communication with a corresponding turbine, wherein the work is performed by combustor reaction products output by the combustor driving the first and second turbo-compressor spools.

27. The computer readable medium of claim 26, wherein each of the at least first and second turbo-compressor spools output an exhaust gas and further comprising at least one of the following operations:
transferring, by an intercooler positioned in a compressed gas flow path between the compressors of the first and second turbo-compressor spools, a portion of thermal energy in the compressed gas compressed by one of the compressors to at least one of the first and second portions of the fuel prior to introduction into the combustor; and
transferring, by an exhaust heat exchanger positioned downstream of the turbines in the first and second turbo-compressor spools, a portion of thermal energy in the exhaust gas to at least one of the first and second portions of the fuel prior to introduction into the combustor.

28. The computer readable medium of claim 20, further comprising at least the following operations:
sensing a vapor pressure in the fuel-containing vessel;
sensing a gas pressure at or just upstream of a combustor inlet; and
applying at least the following rules:
when the combustor requires fuel and the pressure sensed by the first pressure sensor exceeds the pressure sensed by the second pressure sensor, open a fuel control throttle valve to enable the first portion of the fuel to flow from the fuel-containing vessel to the combustor;
when the combustor requires fuel and the pressure sensed by the first pressure sensor is less than the pressure sensed by the second pressure sensor and a pump in fluid communication with the first fuel path is not available, do not open the fuel control throttle valve but enable the second portion of the fuel to flow from the fuel-containing vessel to the combustor;
when the combustor requires fuel and the pressure sensed by the first pressure sensor is less than the pressure sensed by the second pressure sensor and a pump in fluid communication with the first fuel path is available, activate the pump in fluid communication with the first fuel path, open a fuel control throttle valve to enable the first portion of the fuel to flow from the fuel-containing vessel to the combustor; and
when the first portion of the fuel fails to satisfy a fuel requirement of the combustor, enable the second portion of the fuel to flow from the fuel-containing vessel to the combustor to satisfy a fuel requirement of the combustor.
